(19) United States
(12) Patent Application Publication
(10) Pub. No.: US 2026/0195862 A1
(43) Pub. Date: Jul. 9, 2026

(54) METHOD, APPARATUS, DEVICE, AND MEDIUM FOR ENHANCING IMAGE QUALITY

(71) Applicant: Douyin Group (HK) Limited, Wan Chai (HK)

(72) Inventors: Meng WANG, Beijing (CN); Li Zhang, Los Angeles, CA (US); Kai Zhang, Los Angeles, CA (US); Shiqi Wang, Beijing (CN); Yue Wang, Beijing (CN)

(21) Appl. No.: 19/553,140

(22) Filed: Feb. 27, 2026

Related U.S. Application Data
(63) Continuation of application No. PCT/CN2024/116163, filed on Aug. 31, 2024.

(30) Foreign Application Priority Data
Aug. 31, 2023 (CN) 202311116996.8

(51) Int. Cl. G06T 5/50; G06T 5/60; G06T 7/20

(52) U.S. Cl. CPC G06T 5/50; G06T 5/60; G06T 7/20; G06T 2207/20084

(57) ABSTRACT

A method, an apparatus, a device, and a medium for enhancing image quality are provided. In the method, an image sequence is obtained, a head and a tail of the image sequence including a head image frame and a tail image frame, respectively, and positions other than the head and the tail in the image sequence each including a set of intermediate image frames. For an intermediate image frame in the set of intermediate image frames, a mapping frame of the intermediate image frame is determined according to an optical flow estimation based on at least one of the head image frame or the tail image frame. The intermediate image frame is adjusted with the mapping frame to determine an enhanced image frame of the intermediate image frame.

### CROSS-REFERENCE TO RELATED APPLICATIONS

The present application is a continuation of International Application No. PCT/CN2024/116163, filed on Aug. 31, 2024, which claims priority to Chinese Patent Application No. 202311116996.8, filed on Aug. 31, 2023 and entitled “METHOD, APPARATUS, DEVICE, AND MEDIUM FOR ENHANCING IMAGE QUALITY”, the contents of which are incorporated herein by reference in their entireties.

### TECHNICAL FIELD

Example implementations of the present disclosure generally relate to image processing and, in particular, to a method, an apparatus, a device, and a computer-readable storage medium for enhancing image quality in variable resolution decoding.

### BACKGROUND

With the development of video processing technology, variable resolution encoding and decoding technology has been proposed. In the encoding process, the original resolution of certain frames in an original video may be preserved at a predetermined interval, and other frames may be compressed. In the decoding process, the compressed video frames may be restored by using the image frames with the original resolution, so that the quality of the decoded video may be better restored to the quality of the original video. However, the encoding and decoding process will damage the quality of the original video, and may cause the restored video to fail to present the original quality, but to have problems such as blurring. At this time, how to perform the video processing process in a more effective manner to enhance the image quality in the video processing process.

### SUMMARY

In a first aspect of the present disclosure, a method for enhancing image quality is provided. In the method, an image sequence is obtained, a head and a tail of the image sequence including a head image frame and a tail image frame, respectively, and positions other than the head and the tail in the image sequence each including a set of intermediate image frames. For an intermediate image frame in the set of intermediate image frames, a mapping frame of the intermediate image frame is determined according to an optical flow estimation based on at least one of the head image frame or the tail image frame. The intermediate image frame is adjusted with the mapping frame to determine an enhanced image frame of the intermediate image frame.

In a second aspect of the present disclosure, an apparatus for enhancing image quality is provided. The apparatus includes: an obtaining module configured to obtain an image sequence, a head and a tail of the image sequence including a head image frame and a tail image frame, respectively, and positions other than the head and the tail in the image sequence each including a set of intermediate image frames; a determination module configured to, for an intermediate image frame in the set of intermediate image frames, determine a mapping frame of the intermediate image frame according to an optical flow estimation based on at least one of the head image frame or the tail image frame; and an adjustment module configured to adjust the intermediate image frame with the mapping frame to determine an enhanced image frame of the intermediate image frame.

In a third aspect of the present disclosure, an electronic device is provided. The electronic device includes: at least one processor; and at least one memory, the at least one memory being coupled to the at least one processor and storing instructions executable by the at least one processor, the instructions, when executed by the at least one processor, causing the electronic device to perform the method according to the first aspect of the present disclosure.

In a fourth aspect of the present disclosure, a non-transitory computer-readable storage medium is provided, having a computer program stored thereon, the computer program, when executed by a processor, causing the processor to implement the method according to the first aspect of the present disclosure.

It should be understood that the content described in this Summary section is neither intended to identify key or essential features of the implementations of the present disclosure, nor is it intended to limit the scope of the present disclosure. Other features of the present disclosure will be readily envisaged through the following description.

### BRIEF DESCRIPTION OF THE DRAWINGS

In the following, the above and other features, advantages, and aspects of the implementations of the present disclosure will become more apparent in combination with the drawings and with reference to the following detailed description. In the drawings, the same or similar reference symbols refer to the same or similar elements, where:

FIG. 1 shows a block diagram of an application environment for enhancing image quality according to an example implementation of the present disclosure;

FIG. 2 shows a block diagram for enhancing image quality according to some implementations of the present disclosure;

FIG. 3 shows a block diagram for enhancing image quality based on an enhancement model according to some implementations of the present disclosure;

FIG. 4 shows a block diagram of an enhancement model according to some implementations of the present disclosure;

FIG. 5 shows a block diagram of each network in an enhancement model according to some implementations of the present disclosure;

FIG. 6 shows a block diagram for generating an enhanced image sequence according to some implementations of the present disclosure;

FIG. 7 shows a flowchart of a method for enhancing image quality according to some implementations of the present disclosure;

FIG. 8 shows a block diagram of an apparatus for enhancing image quality according to some implementations of the present disclosure; and

FIG. 9 shows a block diagram of a device capable of implementing multiple implementations of the present disclosure.

### DETAILED DESCRIPTION OF EMBODIMENTS

The implementations of the present disclosure will be described in more detail below with reference to the drawings. Although some implementations of the present disclosure are shown in the drawings, it should be understood that the present disclosure may be implemented in various forms and should not be construed as being limited to the implementations set forth herein. Rather, these implementations are provided for a more thorough and complete understanding of the present disclosure. It should be understood that the drawings and implementations of the present disclosure are only used for example purposes, and are not used to limit the protection scope of the present disclosure.

In the description of the implementations of the present disclosure, the term “include/comprise” and similar terms should be understood as openness, that is, “include/comprise but not limited to”. The term “based on” should be understood as “based at least in part on”. The term “an implementation” or “the implementation” should be understood as “at least one implementation”. The term “some implementations” should be understood as “at least some implementations”. Other explicit and implicit definitions may also be included below. As used herein, the term “model” may represent an association between various data. For example, the above association may be acquired based on various technical solutions that are currently known and/or will be developed in the future.

It may be understood that the data involved in the technical solution (including but not limited to the data itself, acquisition or use of the data) should comply with requirements of corresponding laws, regulations, and related provisions.

It may be understood that before using the technical solutions disclosed in the embodiments of the present disclosure, the user should be informed of the type, range of use, use scenarios, etc., of personal information involved in the present disclosure in an appropriate manner and the authorization of the user should be obtained according to relevant laws and regulations.

For example, in response to receiving an active request from a user, prompt information is sent to the user to clearly prompt the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-restrictive implementation, in response to receiving an active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and acquiring user authorization is only illustrative, and does not limit the implementations of the present disclosure. Other manners that satisfy the relevant laws and regulations may also be applied in the implementations of the present disclosure.

The term “in response to” used herein represents a state in which a corresponding event occurs or a condition is satisfied. It will be understood that the time of execution of a subsequent action performed in response to the event or condition is not necessarily strongly correlated with the time at which the event occurs or the condition is satisfied. For example, in some cases, the subsequent action may be performed immediately when the event occurs or the condition is satisfied; in other cases, the subsequent action may be performed after a period of time has elapsed since the event occurred or the condition was satisfied.

### Example Environment

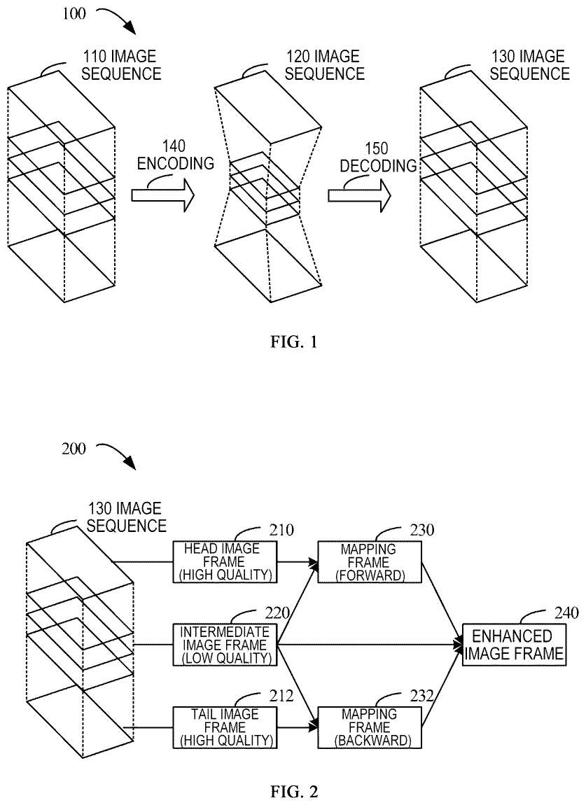

With the development of video processing technology, variable resolution encoding and decoding technology has been proposed. An application environment according to an example implementation of the present disclosure is described with reference to FIG. 1, which shows a block diagram 100 of an application environment for enhancing image quality according to an example implementation of the present disclosure. As shown in FIG. 1, an image sequence 110 may represent an original image sequence to be processed, the image sequence may include multiple image frames, and each of the image frames has an original high resolution. In an encoding process 140, the original resolution of certain frames in the image sequence 110 may be preserved at a predetermined interval.

For example, 16 frames (or another number of frames) may be used as the predetermined interval. The original video may be divided into multiple groups every 16 frames. In each group, the image frames at the head position and the tail position may be maintained at the original resolution, and compression processing (for example, a down-sampling operation with a predetermined coefficient (for example, 2), etc.) may be performed on the intermediate image frames at positions other than the head position and the tail position. For ease of description, the original resolution of the original video may be referred to as a first resolution (or a high resolution), and the resolution of the compressed intermediate image frames may be referred to as a second resolution (or a low resolution). At this time, the data amount of the encoded image sequence 120 will be greatly reduced, so that it is more suitable for subsequent processing such as storage and/or transmission.

In a decoding process 150, a decoder may be used to process the image sequence 120. The decoder may use the reference image frames with the high resolution at the head position and the tail position in the image sequence 120 to restore each of the compressed intermediate image frames, so that the quality of the decoded video may be better restored to the quality of the original video. However, the encoding and decoding process will damage the quality of the original video, and may cause the restored video to fail to present the original quality, but to have problems such as blurring. At this time, how to perform the video processing process in a more effective manner to enhance the image quality in the video processing process.

### Summary of Enhancing Image Quality

In order to at least partially solve the deficiencies in the prior art, according to an example implementation of the present disclosure, a method for enhancing image quality is proposed. In summary, in the decoding process 150, for the image frames with high image quality at the head position and the tail position in the image sequence 130, the intermediate image frame with low image quality at the intermediate position may be enhanced. For example, an optical flow estimation algorithm may be used to determine a mapping frame associated with the intermediate image frame, and then the quality of the intermediate image frame may be enhanced based on the mapping frame.

The summary according to an example implementation of the present disclosure is described with reference to FIG. 2, which shows a block diagram 200 for enhancing image quality according to some implementations of the present disclosure. As shown in FIG. 2, the image sequence 130 may be obtained. Here, the head position of the image sequence 130 may include a head image frame 210 with high image quality, and the tail position may include a tail image frame 212 also with high image quality. Further, the positions other than the head and the tail in the image sequence 120 each include a set of intermediate image frames with low image quality.

It should be understood that although each of the image frames in the image sequence 130 has the original resolution of the video, the intermediate image frame has undergone a compression operation in the encoding process, and thus the image quality of the corresponding decoded image frame may not reach the original image quality before compression. At this time, an image enhancement operation needs to be performed, and the head image frame and/or the tail image frame may be used to improve the quality of the intermediate image frame.

According to an example implementation of the present disclosure, the image sequence 120 may include a predetermined number of multiple image frames (for example, represented by a positive integer n). At this time, the first image frame and the nth image frame in the image sequence 130 have high image quality, and the second image frame to the n−1th image frame in the image sequence 120 have low image quality. For an intermediate image frame 220 in the set of intermediate image frames, a mapping frame of the intermediate image frame 220 may be determined according to an optical flow estimation based on at least one of the head image frame 210 or the tail image frame 212.

It should be understood that the optical flow refers to a movement of a target pixel in an image caused by a movement of an object in the image or a movement of a camera in two consecutive frames of images. It is a movement pattern of an object surface and edges in a visual scene caused by the relative movement between an observer and the scene. According to an example implementation of the present disclosure, a mapping frame between the intermediate image frame 220 and the head image frame 210 (and/or the tail image frame 212) may be determined based on an optical flow estimation technique, that is, the movement pattern of an object in two frames of images may be determined, and then the image quality in the intermediate image frame 220 may be enhanced by using the movement pattern and the high-definition image in the head image frame 210 (and/or the tail image frame 212) with high image quality.

According to an example implementation of the present disclosure, the mapping frame may include a forward mapping frame 230 and/or a backward mapping frame 232. Here, the mapping frame 230 is determined based on the head image frame 210 and the intermediate image frame 220, and the mapping frame 232 is determined based on the tail image frame 212 and the intermediate image frame 220. Specifically, at least one of the mapping frame 230 or the mapping frame 232 may be determined, and the determined mapping frame may be used to adjust the intermediate image frame 220, thereby improving the image quality. In other words, the enhanced image frame 240 of the intermediate image frame may be determined based on the mapping frame.

At this time, the enhanced image frame 240 is an image enhanced by the head image frame 210 and/or the tail image frame 212, and thus has better image quality than the intermediate image frame 220. That is, the intermediate data frame 220 has a restored clear image with the original high resolution. With the example implementation of the present disclosure, the quality of each of the image frames in the image sequence may be improved without increasing the size of the image sequence. In this way, the image quality can be improved and the visual experience of the user can be improved while ensuring the video compression rate.

### Detailed Process of Enhancing Image Quality

The summary according to an example implementation of the present disclosure has been described. Hereinafter, the symbolic representation of each of the terms involved in the processing process is first described. According to an example implementation of the present disclosure, after entering the encoder, the original video may be down-sampled with 16 frames (or another number of frames) as a group of pictures (abbreviated as GoP). That is, except for the head frame and the tail frame, each intermediate image frame

$${F}_{n ∉ 16 x}^{H}$$

will be down-sampled according to the spatial down-sampling parameters set by the variable resolution encoding, as shown in Formula 1:

$${F}_{n ∉ 16 x}^{L} = ( {F}_{n ∉ 16 x}^{H} ) {↓}_{d} + {ε}_{D} \qquad Formula 1$$

In the above formula, F represents an image frame in the video; the subscript n represents a temporal order of each frame (that is, the number of the position where the frame is located), H represents the original high resolution, L represents the down-sampled low resolution, and n∈16x represents an intermediate image frame at a position other than the head and tail positions. At this time,

$${F}_{n ∉ 16 x}^{L}$$

represents an intermediate image frame located outside the head and tail in the encoded video, and

$${F}_{n ∉ 16 x}^{H}$$

represents an intermediate image frame located outside the head and tail in the video before encoding. (⋅)↓_{d} represents a down-sampling operation with a coefficient of d (for example, d=2, representing that the width and height after down-sampling are half of the original values, and the coefficient may be set to other values). ε_{D} represents noise introduced by the down-sampling process. x represents an integer. The encoder encodes the image frame

$${F}_{n ∈ 16 x}^{H}$$

with high image quality and the image frame

$${F}_{n ∉ 16 x}^{L}$$

with low image quality, and introduces a compression loss ε_{(H,L)}:

$$( {\hat{F}}_{n ∈ 16 x}^{H} , {\hat{F}}_{n ∉ 16 x}^{L} ) = ( {F}_{n ∈ 16 x}^{H} , {F}_{n ∉ 16 x}^{L} ) + {ε}_{( H , L )} \qquad Formula 2$$

In the above formula,

$${\hat{F}}_{n ∈ 16 x}^{H}$$

represents a decoded image frame located at the head and tail positions,

$${\hat{F}}_{n ∉ 16 x}^{L}$$

represents a decoded image frame located at an intermediate position other than the head and tail positions,

$${F}_{n ∉ 16 x}^{L}$$

represents an intermediate image frame located outside the head and tail in the encoded video,

$${F}_{n ∉ 16 x}^{H}$$

represents an intermediate image frame located outside the head and tail in the video before encoding, and ε_{(H,L)} represents a compression loss.

In the decoding process, the decoder interpolates and up-samples the reconstructed frame with low image quality to restore it to the original resolution. The noise introduced by the interpolation is recorded as ε_{U}, and the up-sampling process may be expressed as:

$${\hat{F}}_{n ∉ 16 x}^{H} = ( {\hat{F}}_{n ∉ 16 x}^{L} ) {↑}_{d} + {ε}_{U} \qquad Formula 3$$

In the above formula,

$${\hat{F}}_{n ∉ 16 x}^{H}$$

represents an intermediate image frame that has been restored to the original resolution after an up-sampling operation is performed on the decoded image, and ε_{U} represents the noise introduced during the operation. At this time, although

$${\hat{F}}_{n ∉ 16 x}^{H}$$

is restored to the original resolution, the image quality of these image frames is lost during the encoding and decoding process.

According to an example implementation of the present disclosure, the two frames with high image quality at the head and the tail in each GoP may be used to enhance the quality of the intermediate image frame, and an enhancement strategy of bidirectional temporal guidance may be adopted. Specifically, the head image frame or the tail image frame in the GoP may be used to perform optical flow estimation with the intermediate image frame to be enhanced, respectively, to determine the corresponding forward mapping frame or backward mapping frame.

According to an example implementation of the present disclosure, a global motion aggregation (abbreviated as GMA) algorithm may be used to determine the mapping frame between two image frames. It should be understood that the GMA algorithm is only a specific example of optical flow estimation. Alternatively and/or additionally, the mapping frame between two image frames may be determined based on other optical flow estimation algorithms that are currently known and/or will be developed in the future.

According to an example implementation of the present disclosure, in the process of determining the mapping frame of the intermediate image frame, the forward mapping frame of the intermediate image frame may be determined according to the optical flow estimation based on the head image frame (as shown in Formula 4.1 below). Further, the backward mapping frame of the intermediate image frame may be determined according to the optical flow estimation based on the tail image frame (as shown in Formula 4.2 below).

$${\vec{v}}_{{f}_{1}} = f ( {\hat{F}}_{0}^{H} , {\hat{F}}_{n}^{H} ) \qquad Formula 4.1$$

$${\vec{v}}_{{f}_{2}} = f ( {\hat{F}}_{16}^{H} , {\hat{F}}_{n}^{H} ) \qquad Formula 4.2$$

In the above formulas,

$${\hat{F}}_{0}^{H}$$

represents the decoded head image frame located at the head position,

$${\hat{F}}_{n}^{H}$$

represents the current intermediate image frame to be processed,

$${\hat{F}}_{16}^{H}$$

represents the tail image frame located at the tail position, \vec{v}_{f}_{₁} represents a forward mapping frame determined based on the head image frame and the intermediate image frame, and \vec{v}_{f}_{₂} represents a backward mapping frame determined based on the tail image frame and the intermediate image frame.

It should be understood that although Formula 4.1 and Formula 4.2 are provided above, in a specific application environment, at least one of Formula 4.1 or Formula 4.2 may be used alone. For example, the forward optical flow estimation or the backward optical flow estimation may be used alone, and one high-precision frame in the forward or backward direction may be used to enhance the image quality of the intermediate image frame. Alternatively and/or additionally, Formula 4.1 and Formula 4.2 may also be used in combination. At this time, both the forward optical flow estimation and the backward optical flow estimation may be used in combination, and then the high-quality images on both the front and back sides of the intermediate image frame may be fully utilized to enhance the image quality of the intermediate image frame in a more effective manner. In this way, the accurate and reliable optical flow estimation technology can be fully utilized to improve the quality of each of the image frames in the decoded video, thereby improving the visualization effect of the entire video.

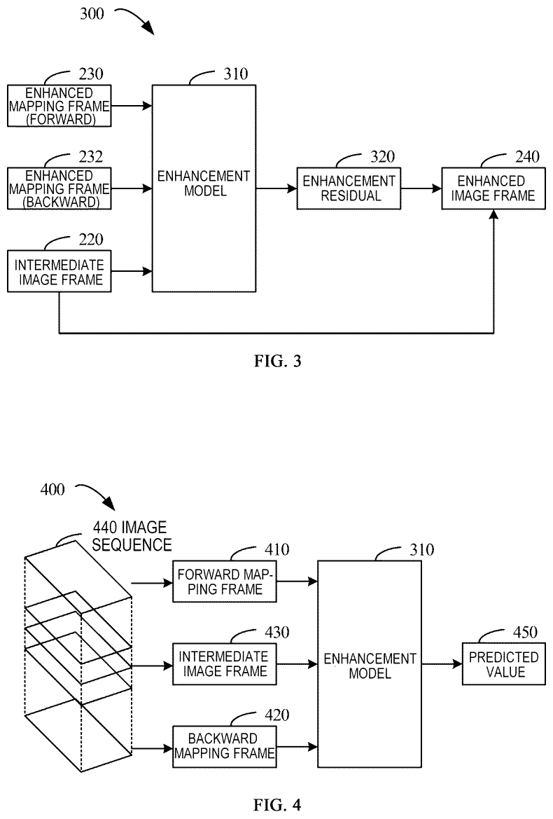

According to an example implementation of the present disclosure, a machine learning technique may be used to determine the enhanced image frame of the intermediate image frame. FIG. 3 shows a block diagram 300 for enhancing image quality based on an enhancement model according to some implementations of the present disclosure. As shown in FIG. 3, an enhancement model 310 may be used to determine an enhancement residual 320 of the intermediate image frame. In the context of the present disclosure, the enhancement residual 320 may represent an amount of change for modifying the intermediate image frame 220, that is, the enhanced image frame 240 may be determined based on the enhancement residual 320 and the intermediate image frame 220.

As shown in FIG. 3, the enhancement model 310 may be trained based on reference data, and the enhancement model 310 may describe an association between a first reference image frame, a second reference image frame corresponding to the first reference image frame, and a reference mapping frame of the second reference image frame. Here, the first reference image frame may have high image quality, and the second reference image frame may have second low image quality.

According to an example implementation of the present disclosure, various machine learning models that are currently known and/or will be developed in the future may be used to construct the enhancement model 310. Further, the enhancement model 310 may be continuously updated with the reference data, so that the enhancement model 310 may accurately describe the association between the intermediate image frame of the compressed video obtained from the variable resolution encoder and the corresponding original intermediate image frame. Further, the quality of the intermediate image frame can be enhanced based on the association, thereby improving the visual experience of the video viewer.

The process of obtaining the enhancement model 310 is described with reference to FIG. 4, which shows a block diagram 400 of an enhancement model according to some implementations of the present disclosure. As shown in FIG. 4, the reference data may be obtained from an image sequence 440, which may be obtained, for example, by performing variable resolution encoding and decoding on a known original image sequence (each image frame has high resolution and high quality). The image sequence 440 may include multiple image frames, the image frames at the head position and the tail position may have high quality, and other intermediate image frames other than the head position and the tail position may have low quality.

At this time, the intermediate image frame 430 may be selected from the image sequence 440, and a forward mapping frame 410 and a backward mapping frame 420 of the intermediate image frame may be determined using Formula 4.1 and Formula 4.2 described above. Further, the forward mapping frame 410, the intermediate image frame 430, and the backward mapping frame 420 may be input to the enhancement model 310, and a predicted value 450 of the enhancement residual for enhancing the intermediate image frame 430 may be determined from the enhancement model 310. Further, the enhancement model 310 may be updated based on the predicted value 450 and the original high-quality reference image frame.

With the example implementation of the present disclosure, the correspondence between each of the image frames in the known original image sequence and the encoded-decoded image sequence may be fully utilized to generate the corresponding reference data. Further, these reference data may be used to update the enhancement model 310 in a direction that the difference between the predicted value and the image residual determined based on the true value is continuously reduced. In this way, the enhancement model 310 can more accurately describe the association between the first reference image frame with high quality, the second reference image frame with low quality corresponding to the first reference image frame, and the reference mapping frame of the second reference image frame.

According to an example implementation of the present disclosure, an intermediate image frame located at a position other than the head and the tail may be selected from an uncompressed original image sequence (also referred to as a reference image sequence) of the image sequence 440 to serve as the first reference image frame. Further, an intermediate image frame corresponding to the first reference image frame selected from the encoded-decoded image sequence (for example, the image sequence 440 shown in FIG. 4) of the original image sequence may be used as the second reference image frame.

According to an example implementation of the present disclosure, a specific position may be specified and the first reference image frame and the second reference image frame may be selected from the original image sequence and the encoded-decoded image sequence, respectively. For example, the intermediate image frame at the ith position (in the case where the GoP includes 16 image frames, 2≤i≤15) may be selected. Specifically, the intermediate image frame at the ith position may be selected from the original image sequence to serve as the first reference image frame, and the intermediate image frame at the ith position may be selected from the encoded-decoded image sequence to serve as the second reference image frame. Further, the above-described formulas may be used to determine the corresponding forward mapping frame and/or backward mapping frame, and then determine a response loss function for updating the enhancement model 310.

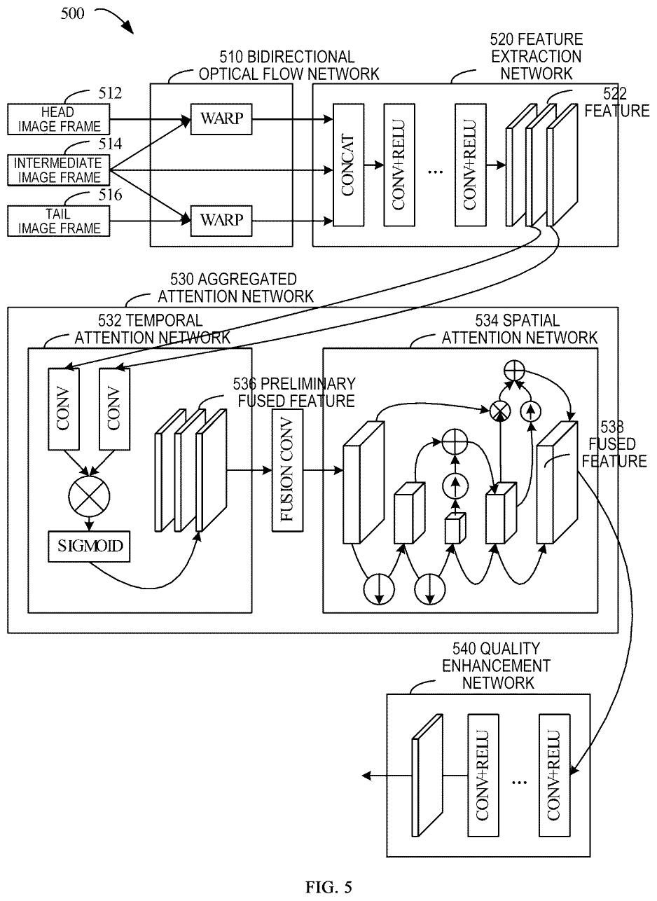

According to an example implementation of the present disclosure, more details of the enhancement model 310 are described with reference to FIG. 5. FIG. 5 shows a block diagram 500 of each of the networks in the enhancement model 310 according to some implementations of the present disclosure. The enhancement model 310 may include multiple networks: a bidirectional optical flow network 510, a feature extraction network 520, an aggregated attention network 530, and a quality enhancement network 540. Each of the networks may be used to perform corresponding processing to determine the final enhancement residual.

The bidirectional optical flow network 510 is first described. The head image frame 512, the intermediate image frame 514, and the tail image frame 516 determined based on the above method may be input to the bidirectional optical flow network 510. Further, corresponding processing may be performed on each of the input image frames to provide input data to the subsequent feature extraction network 520. Specifically, the mapping module (for example, a warp module) shown in FIG. 5 may be configured to perform a mapping operation. For example, the mapping operation may be performed based on the following formula.

$${\tilde{W}}_{n ←}^{H} = D ( {\vec{v}}_{{f}_{1}} ) \cdot {\hat{F}}_{0}^{H} + {ε}_{{t}_{1}} \qquad Formula 5.1$$

$${\tilde{W}}_{n \to }^{H} = D ( {\vec{v}}_{{f}_{2}} ) \cdot {\hat{F}}_{16}^{H} + {ε}_{{t}_{2}} \qquad Formula 5.2$$

In the above formulas,

$${\tilde{W}}_{n ←}^{H}$$

represents the mapped forward mapping frame, \vec{v}_{f}_{₁} represents the forward mapping frame determined based on the above formula,

$${\hat{F}}_{0}^{H}$$

represents the head image frame, and εₜ_{₁} represents the noise introduced in the forward mapping process. Similarly,

$${\tilde{W}}_{n \to }^{H}$$

represents the mapped backward mapping frame, \vec{v}_{f}_{₂} represents the backward mapping frame determined based on the above formula,

$${\hat{F}}_{16}^{H}$$

represents the tail image frame, and εₜ_{₂} represents the noise introduced in the backward mapping process. Further, the data

$${\tilde{W}}_{n ←}^{H} , {\hat{F}}_{n}^{H} , and {\tilde{W}}_{n \to }^{H}$$

may be input to the subsequent feature extraction network 520.

It should be understood that although FIG. 5 shows an example of using the bidirectional optical flow network 510 to process the head image frame 512, the intermediate data frame 514, and the tail image frame 516, alternatively and/or additionally, the function of the bidirectional optical flow network 510, or a part of the function may be completed outside the enhancement model 310. For example, the intermediate image frame and the corresponding forward mapping frame and backward mapping frame may be directly obtained outside the enhancement model. At this time, the intermediate image frame and the corresponding forward mapping frame and backward mapping frame may be directly input to the feature extraction module 520 for subsequent processing.

According to an example implementation of the present disclosure, the feature extraction network 520 in the enhancement model 310 may be used to extract a feature from the intermediate image frame and the mapping frame. As shown in FIG. 5, the feature extraction network 520 may include a concatenating module (the concat module as shown in FIG. 5), and a subsequent convolutional network. An 8-layer (or another number of layers) convolutional layer with ReLU may be used to extract a feature 522. Specifically, the feature extraction network 520 may extract a feature based on the following formula:

$$F = ( {F}_{t} , {F}_{1} , {F}_{2} ) = Conv ( [ {\hat{F}}_{n}^{H} , {\tilde{W}}_{n ←}^{H} , {\tilde{W}}_{n \to }^{H} ] ) \qquad Formula 6$$

In the above formula, F represents the feature extracted by the feature extraction network 520, which may include three components: Fₜ, F₁, F₂, Conv( ) represents a convolution operation, and

$${\hat{F}}_{n}^{H} , {\tilde{W}}_{n ←}^{H} , {\tilde{W}}_{n \to }^{H}$$

respectively represent the data output by the upstream bidirectional optical flow network 510.

Further, the aggregated attention network 530 in the enhancement model 310 may be used to process the feature 522 output by the upstream feature extraction network 520 to further determine a fused feature 538 of the intermediate image frame. As shown in FIG. 5, the aggregated attention network 530 may include a temporal attention network 532 and a spatial attention network 534. At this time, the temporal attention network 532 in the aggregated attention network 530 may be used to determine a preliminary fused feature 536 of the intermediate image frame based on the feature 522. Further, the spatial attention network 534 in the aggregated attention network 530 may be used to determine the final fused feature 538 of the intermediate image frame based on the preliminary fused feature 536.

As shown in FIG. 5, the temporal attention network 532 may include a convolutional module (for example, the conv module in FIG. 5), a product module (for example, the element-wise product module in FIG. 5), and an activation module (for example, the Sigmoid module in FIG. 5). These modules may generate the preliminary fused feature 536 based on the following formula, that is, determine the associated attention weight of the intermediate image frame.

$${ω}_{1} = sigmoid ( θ ( {F}_{t} ) ⊙ ϕ ( {F}_{1} ) ) \qquad Formula 7$$

In the above formula, Fₜ and F₁ respectively represent feature components from the feature extraction network, θ and φ respectively represent parameters of the convolutional network, ⊙ represents a multiplication operation, and sigmoid( ) represents the corresponding activation function. According to an example implementation of the present disclosure, the specific value of each parameter may be determined based on various functional forms that are currently known and/or will be developed in the future, and thus will not be repeated. Further, the preliminary fused feature 536 may be processed by a fusion function for subsequent spatial attention-related processing.

$${\tilde{F}}_{1} = {F}_{1} ⊙ {ω}_{1} \qquad Formula 8$$

According to an example implementation of the present disclosure, similar processing may be performed for other components to obtain the corresponding result \tilde{F}ₜ, \tilde{F}₂. Further, further processing may be performed for each of the obtained preliminary fused features based on the following formula.

$${F}_{fusion} = FusionConv ( [ {\tilde{F}}_{1} , {\tilde{F}}_{t} , {\tilde{F}}_{2} ] ) \qquad Formula 9$$

In the above formula, F_{fusion} represents the result after the fusion processing, FusionConv( ) represents the fusion function, and \tilde{F}₁, \tilde{F}ₜ, \tilde{F}₂ respectively represent the output result of the temporal attention network 532. At this time, in the spatial attention network 534, the attention operation in the spatial range may be further processed to obtain the final fused feature 533. Specifically, the feature obtained by the initial fusion is down-sampled twice by convolution, and then the spatial attention is obtained by up-sampling and summing from top to bottom. Finally, a fused feature map is generated by element-wise multiplication. According to an example implementation of the present disclosure, for example, the fused feature 538 may be determined based on the following formula.

$${F}^{′} = {F}_{fusion} {↓}_{2} , {F}^{″} = {F}^{′} {↓}_{2} \qquad Formula 10$$

$${\hat{F}}^{′} = {F}^{′} + {F}^{″} {↑}_{2} \qquad Formula 11$$

$${\hat{F}}_{fusion} = {\hat{F}}^{′} {↑}_{2} ⊙ {F}_{fusion} + {\hat{F}}^{′} {↑}_{2} \qquad Formula 12$$

In the above formulas, F′ and F″ respectively represent the processing results after two down-sampling operations, ↓₂ represents a down-sampling operation, ↑₂ represents an up-sampling operation, “+” represents an element-wise addition operation, \hat{F}′ represents an intermediate result of the addition operation, and ⊙ represents an element-wise product operation. In this way, the process of extracting the fused feature can be converted into a mathematical operation, so that the fused feature 538 can more accurately describe the management relationship between each of the image frames, thereby improving the accuracy of the entire enhancement network.

Further, the aggregated attention network 530 may output the fused feature 538 to the downstream quality enhancement network 540, and further use the quality enhancement network in the enhancement model to determine the enhancement residual based on the fused feature. As shown in FIG. 5, the quality enhancement network 540 may include a residual network, and the enhancement residual R^{QE} may be obtained through the convolutional layer. Then, through the bidirectional guidance module and the residual, the enhancement residual for enhancing the intermediate image frame 514 may be generated using the following formula.

$${R}^{QE} = {ℱ}_{res} ( {\hat{F}}_{fusion} ) \qquad Formula 13$$

In the above formula, R^{QE} represents the enhancement residual, Fᵣₑₛ( ) represents the processing function of the residual network, and \hat{F}_{fusion} represents the fused feature 538 generated according to the above formula. Further, the following formula may be used to perform enhancement processing on the intermediate image frame to obtain the enhanced image frame.

$${F}_{n}^{QE} = {R}^{QE} + {\hat{F}}_{n}^{H} \qquad Formula 14$$

In the above formula,

$${F}_{n}^{QE}$$

represents the enhanced image frame with high quality,

$${\hat{F}}_{n}^{H}$$

represents the intermediate image frame 514, and R^{QE} represents the enhancement residual for performing enhancement processing on

$${\hat{F}}_{n}^{H} .$$

With the example implementation of the present disclosure, the enhancement model may be used to fully learn the association between each of the image frames in the reference data, thereby enhancing the image quality in a more accurate manner.

According to an example implementation of the present disclosure, each piece of the reference data is processed based on the specific network structure shown in FIG. 5 to obtain the predicted value of the corresponding enhancement residual. Further, the enhancement model may be updated based on the following loss function in a manner that minimizes the difference between the predicted value and the true value of the enhancement residual.

$$ℒ = {( {F}_{n}^{QE} - {F}_{n ∉ 16 x}^{H} )}^{2} \qquad Formula 15$$

In the above formula, [symbol] represents the loss function,

$${F}_{n}^{QE}$$

represents the predicted value of the enhanced image frame, and

$${F}_{n ∉ 16 x}^{H}$$

represents the true value of the intermediate image frame in the original image sequence used as the reference data. With the example implementation of the present disclosure, a large number of image sequences may be used to construct reference samples for updating the enhancement model. In this way, the enhancement model can continuously output the corresponding enhancement residual and enhanced image frame in a more accurate direction.

According to an example implementation of the present disclosure, the enhancement model may be continuously updated in an iterative manner until the enhancement model 310 meets a predetermined stop condition. For example, the training may be stopped when the loss function reaches a predetermined range, and the training may be stopped when the training process reaches a predetermined number of rounds, etc.

According to an example implementation of the present disclosure, in the case where the trained enhancement model 310 has been obtained, the enhancement model 310 may be used to process each of the intermediate image frames in the decoded video one by one. For example, a set of enhanced image frames of a set of intermediate image frames may be obtained, respectively. Further, an enhanced image sequence corresponding to the image sequence may be generated using the head image frame, the set of enhanced image frames, and the tail image frame. More details about the enhancement process are described with reference to FIG. 6.

FIG. 6 shows a block diagram 600 for generating an enhanced image sequence according to some implementations of the present disclosure. As shown in FIG. 6, the image sequence 120 represents a compressed video, and the compressed video may be obtained by performing an encoding operation on an original video using a variable resolution encoder. Here, the original video has a high first resolution. In the image sequence 120, the image frames at the head position and the tail position have the first resolution, and the intermediate image frames at other positions have a low second resolution. A decoding operation 150 may be performed on the compressed video to obtain the decoded image sequence 130. At this time, each of the image frames in the image sequence 130 has a high resolution, however, the image quality of the intermediate image frame at the intermediate position is low.

Each of the intermediate image frames may be processed one by one using the process described above to generate the corresponding enhanced image frames 610, 612, . . . , 614, etc. Further, these enhanced image frames 610, 612, . . . , 614 and the extracted reference image frames with high image quality at the head position and the tail position may be used to generate an enhanced image sequence 620. At this time, each of the image frames in the enhanced image sequence has high image quality, thus the visual experience of the viewer may be improved.

According to an example implementation of the present disclosure, by combining variable resolution encoding, a high-resolution reconstruction frame may be used to guide the quality enhancement of a low-resolution reconstruction frame, and a bidirectional optical flow network may greatly improve the accuracy of motion information modeling. Further, in the process of variable resolution encoding, several video frames are grouped, and the first and last frames are encoded with high resolution, which may save bit rate and effectively assist video enhancement.

It should be understood that the method described above may be used to process videos including different scenes. For example, a person video, a landscape video, an animation scene, a game video, etc. may be processed. At present, a large amount of video content in game scenes has appeared, such as live streaming and recorded video playback. Generally speaking, compared with real scenes, animation scenes and game scenes are relatively simple, and the difference between the content of each of the frames in the video may be relatively small. At this time, an example implementation of the present disclosure is more helpful for using the high-definition reference image frames at the head position and the tail position of the GOP to enhance the visual effect of the intermediate image frame.

With the example implementation of the present disclosure, the proposed method may improve the reconstruction quality of variable resolution compression of animation and/or game videos, and reduce the encoding delay of animation transmission, game live streaming, and cloud game systems. Compared with traditional fixed resolution encoding or variable resolution encoding, the proposed method may bring significant improvement in subjective and objective quality, while reducing the storage and transmission overhead of game videos to a certain extent.

According to an example implementation of the present disclosure, for a specific animation scene and/or game scene, a pre-recorded video may be used to generate the corresponding reference sample according to the method described above. Further, these reference samples may be used to train enhancement models dedicated to different animation scenes and/or game scenes, respectively. In this way, the accuracy and performance of the enhancement model can be further improved, thereby improving the visual experience of the viewer.

### Example Process

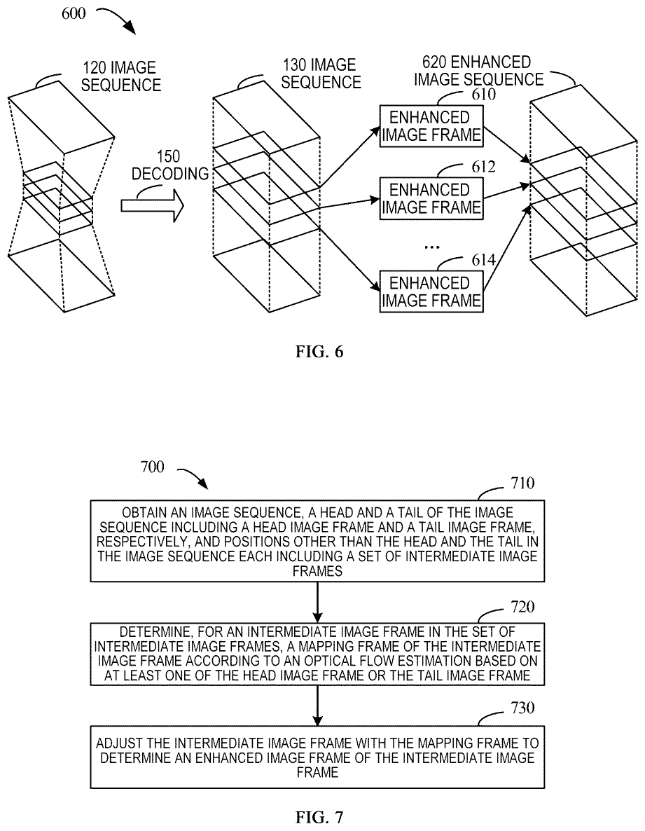

FIG. 7 shows a flowchart of a method 700 for enhancing image quality according to some implementations of the present disclosure. At a block 710, an image sequence is obtained, the head and the tail of the image sequence include a head image frame and a tail image frame, respectively, and positions other than the head and the tail in the image sequence each include a set of intermediate image frames. At a block 720, for an intermediate image frame in the set of intermediate image frames, a mapping frame of the intermediate image frame is determined according to an optical flow estimation based on at least one of the head image frame or the tail image frame. At a block 730, the intermediate image frame is adjusted with the mapping frame to determine an enhanced image frame of the intermediate image frame.

According to an example implementation of the present disclosure, determining the mapping frame of the intermediate image frame includes: determining a forward mapping frame of the intermediate image frame according to the optical flow estimation based on the head image frame.

According to an example implementation of the present disclosure, determining the mapping frame includes: determining a backward mapping frame of the intermediate image frame according to the optical flow estimation based on the tail image frame.

According to an example implementation of the present disclosure, determining the enhanced image frame of the intermediate image frame includes: determining an enhancement residual of the intermediate image frame using an enhancement model, the enhancement model describing an association between a first reference image frame, a second reference image frame corresponding to the first reference image frame, and a reference mapping frame of the second reference image frame; and determining the enhanced image frame based on the enhancement residual and the intermediate image frame.

According to an example implementation of the present disclosure, the enhancement model is obtained based on: determining, based on the reference mapping frame, a predicted value of an enhancement residual corresponding to the first reference image frame using the enhancement model; and determining the enhancement model based on the predicted value and the first reference image frame.

According to an example implementation of the present disclosure, the first reference image frame is an intermediate reference image frame located at a position other than the head and the tail and selected from a reference image sequence.

According to an example implementation of the present disclosure, the second reference image frame is an intermediate image frame corresponding to the first reference image frame and selected from an encoded image sequence of the reference image sequence.

According to an example implementation of the present disclosure, determining the enhancement residual of the intermediate image frame using the enhancement model includes: extracting a feature from the intermediate image frame and the mapping frame using a feature extraction network in the enhancement model; determining a fused feature of the intermediate image frame based on the features using a fused attention network in the enhancement model; and determining the enhancement residual based on the fused feature using a quality enhancement network in the enhancement model.

According to an example implementation of the present disclosure, determining the fused feature includes: determining a preliminary fused feature of the intermediate image frame based on the features using a temporal attention network in the fused attention network; and determining the fused feature of the intermediate image frame based on the preliminary fused feature using a spatial attention network in the fused attention network.

According to an example implementation of the present disclosure, determining the enhancement residual of the intermediate image frame includes: determining the enhancement residual of the intermediate image frame based on the fused feature using a residual network in the quality enhancement network.

According to an example implementation of the present disclosure, the method further includes: obtaining a set of enhanced image frames of the set of intermediate image frames, respectively; and generating an enhanced image sequence corresponding to the image sequence using the head image frame, the set of enhanced image frames, and the tail image frame.

According to an example implementation of the present disclosure, the image sequence is obtained by decoding a compressed video using a variable resolution decoder, and the compressed video is obtained by performing an encoding operation on an original video using a variable resolution encoder.

According to an example implementation of the present disclosure, an image quality of the head image frame and the tail image frame is higher than an image quality of the set of intermediate image frames.

### Example Apparatus and Device

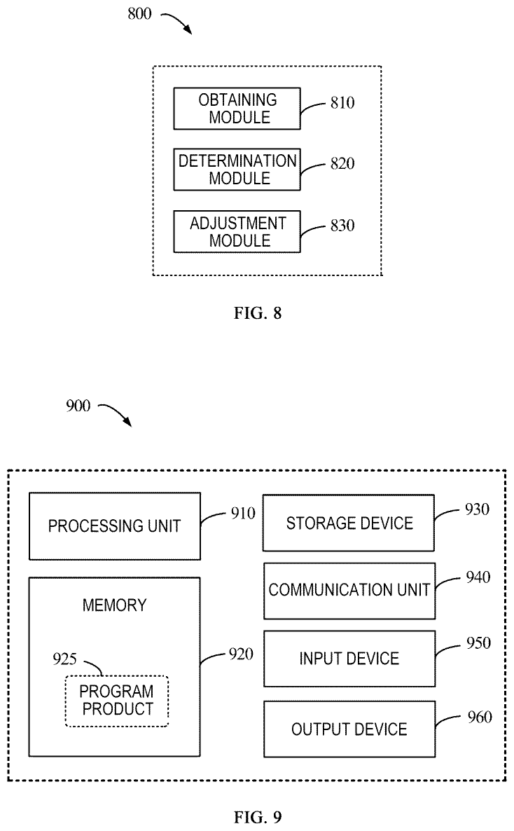

FIG. 8 shows a block diagram of an apparatus 800 for enhancing image quality according to some implementations of the present disclosure. The apparatus 800 includes: an obtaining module 810 configured to obtain an image sequence, a head and a tail of the image sequence including a head image frame and a tail image frame, respectively, and positions other than the head and the tail in the image sequence each including a set of intermediate image frames; a determination module 820 configured to determine, for an intermediate image frame in the set of intermediate image frames, a mapping frame of the intermediate image frame according to an optical flow estimation based on at least one of the head image frame or the tail image frame; and an adjustment module 830 configured to adjust the intermediate image frame with the mapping frame to determine an enhanced image frame of the intermediate image frame.

According to an example implementation of the present disclosure, the determination module 820 includes: a first determination module configured to determine a forward mapping frame of the intermediate image frame according to the optical flow estimation based on the head image frame.

According to an example implementation of the present disclosure, the determination module 820 includes: a second determination module configured to determine the mapping frame includes: determining a backward mapping frame of the intermediate image frame according to the optical flow estimation based on the tail image frame.

According to an example implementation of the present disclosure, the determination module 820 includes: an invoking module configured to determine an enhancement residual of the intermediate image frame using an enhancement model, the enhancement model describing an association between a first reference image frame, a second reference image frame corresponding to the first reference image frame, and a reference mapping frame of the second reference image frame; and an enhancement module configured to determine the enhanced image frame based on the enhancement residual and the intermediate image frame.

According to an example implementation of the present disclosure, the enhancement model is obtained based on: determining, based on the reference mapping frame, a predicted value of an enhancement residual corresponding to the first reference image frame using the enhancement model; and determining the enhancement model based on the predicted value and the first reference image frame.

According to an example implementation of the present disclosure, the first reference image frame is an intermediate reference image frame located at a position other than the head and the tail and selected from a reference image sequence.

According to an example implementation of the present disclosure, the second reference image frame is an intermediate image frame corresponding to the first reference image frame and selected from an encoded image sequence of the reference image sequence.

According to an example implementation of the present disclosure, the invoking module includes: an extraction module configured to extract a feature from the intermediate image frame and the mapping frame using a feature extraction network in the enhancement model; a fusion module configured to determine a fused feature of the intermediate image frame based on the features using a fused attention network in the enhancement model; and a residual determination module configured to determine the enhancement residual based on the fused feature using a quality enhancement network in the enhancement model.

According to an example implementation of the present disclosure, the fusion module is configured to determine the fused feature includes: a temporal module configured to determine a preliminary fused feature of the intermediate image frame based on the features using a temporal attention network in the fused attention network; and a spatial module configured to determine the fused feature of the intermediate image frame based on the preliminary fused feature using a spatial attention network in the fused attention network.

According to an example implementation of the present disclosure, the residual determination module includes: an enhancement residual determination module configured to determine the enhancement residual of the intermediate image frame based on the fused feature using a residual network in the quality enhancement network.

According to an example implementation of the present disclosure, the apparatus further includes: a video processing module configured to obtain a set of enhanced image frames of the set of intermediate image frames, respectively; and a video generation module configured to generate an enhanced image sequence corresponding to the image sequence using the head image frame, the set of enhanced image frames, and the tail image frame.

According to an example implementation of the present disclosure, the image sequence is obtained by decoding a compressed video using a variable resolution decoder, and the compressed video is obtained by performing an encoding operation on an original video using a variable resolution encoder.

According to an example implementation of the present disclosure, an image quality of the head image frame and the tail image frame is higher than an image quality of the set of intermediate image frames.

FIG. 9 shows a block diagram of a device 900 capable of implementing multiple implementations of the present disclosure. It should be understood that the computing device 900 shown in FIG. 9 is only for example, and should not constitute any limitation on the function and scope of the implementations described herein. The computing device 900 shown in FIG. 9 may be used to implement the method described above.

As shown in FIG. 9, the computing device 900 is in the form of a general computing device. The components of the computing device 900 may include, but are not limited to, one or more processors or processing units 910, a memory 920, a storage device 930, one or more communication units 940, one or more input devices 950, and one or more output devices 960. The processing unit 910 may be an actual or virtual processor and may execute various processes based on the programs stored in the memory 920. In a multi-processor system, multiple processing units execute computer executable instructions in parallel to improve the parallel processing capability of the computing device 900.

The computing device 900 typically includes multiple computer storage medium. Such medium may be any available medium that is accessible to the computing device 900, including but not limited to volatile and non-volatile medium, removable and non-removable medium. The memory 920 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 930 may be a removable or non-removable medium, and may include a machine readable medium such as a flash drive, a disk, or any other medium, which may be used to store information and/or data (such as training data for training) and may be accessed within the computing device 900.

The computing device 900 may further include additional removable/non-removable, volatile/non-volatile memory medium. Although not shown in FIG. 9, a magnetic disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 920 may include a computer program product 925, which has one or more program modules configured to perform various methods or acts of various implementations of the present disclosure.

The communication unit 940 implements communication with other computing devices through the communication medium. Additionally, the functions of the components of the computing device 900 may be implemented by a single computing cluster or multiple computing machines, which may communicate through communication connections. Therefore, the computing device 900 may use a logical connection with one or more other servers, a network personal computer (PC), or another network node to operate in a networked environment.

The input device 950 may be one or more input devices, such as a mouse, a keyboard, a tracking ball, etc. The output device 960 may be one or more output devices, such as a display, a speaker, a printer, etc. The computing device 900 may also communicate with one or more external devices (not shown) as needed through the communication unit 940, the external devices such as the storage device, the display device, etc., communicate with one or more devices that enable the user to interact with the computing device 900, or communicate with any devices (for example, a network card, a modem, etc.) that enable the computing device 900 to communicate with one or more other computing devices. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is further provided a computer program product tangibly stored on a non-transitory computer-readable medium and including computer executable instructions, and the computer executable instructions are executed by a processor to implement the method described above. According to an example implementation of the present disclosure, there is provided a computer program product having a computer program stored thereon, where the program, when executed by a processor, implements the method described above.

Aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, an apparatus for implementing the functions/actions specified in one or more blocks of the flowcharts and/or block diagrams is produced. These computer-readable program instructions may also be stored in a computer-readable storage medium, which instructions cause the computer, the programmable data processing apparatus, and/or other devices to work in a specific manner, so that the computer-readable medium stored with the instructions includes an article of manufacture that includes instructions for implementing various aspects of the functions/actions specified in one or more blocks of the flowcharts and/or block diagrams.

The computer-readable program instructions may be loaded onto a computer, other programmable data processing apparatus, or other devices, so that a series of operations and steps are performed on the computer, other programmable data processing apparatus, or other devices to produce a computer-implemented process, so that the instructions executed on the computer, other programmable data processing apparatus, or other devices implement the functions/actions specified in one or more blocks of the flowcharts and/or block diagrams.

The flowcharts and block diagrams in the drawings show the possibly implemented architectures, functions, and operations of the systems, methods, and computer program products according to multiple implementations of the present disclosure. In this regard, each block in the flowchart or block diagram may represent a module, program segment, or part of an instruction, which module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combination of blocks in the block diagrams and/or flowcharts may be implemented by a dedicated hardware-based system that performs specified functions or acts, or may be implemented by a combination of dedicated hardware and computer instructions.

The implementations of the present disclosure have been described above, and the above description is an example, non-exhaustive, and not limited to the disclosed implementations. Without departing from the scope and spirit of the illustrated implementations, many modifications and changes will be apparent to those of ordinary skill in the art. The choice of terms used herein is intended to best explain the principles of the implementations, the practical applications or improvements to the technology in the market, or to enable other those of ordinary skill in the art to understand the implementations disclosed herein.

1. A method for enhancing image quality, comprising:
obtaining an image sequence, a head and a tail of the image sequence comprising a head image frame and a tail image frame, respectively, and positions other than the head and the tail in the image sequence each comprising a set of intermediate image frames;
determining, for an intermediate image frame in the set of intermediate image frames, a mapping frame of the intermediate image frame according to an optical flow estimation based on at least one of the head image frame or the tail image frame; and
adjusting the intermediate image frame with the mapping frame to determine an enhanced image frame of the intermediate image frame.

2. The method of claim 1, wherein determining the mapping frame of the intermediate image frame comprises: determining a forward mapping frame of the intermediate image frame according to the optical flow estimation based on the head image frame.

3. The method of claim 1, wherein determining the mapping frame of the intermediate image frame comprises: determining a backward mapping frame of the intermediate image frame according to the optical flow estimation based on the tail image frame.

4. The method of claim 1, wherein determining the enhanced image frame of the intermediate image frame comprises:
determining an enhancement residual of the intermediate image frame using an enhancement model, the enhancement model describing an association between a first reference image frame, a second reference image frame corresponding to the first reference image frame, and a reference mapping frame of the second reference image frame; and
determining the enhanced image frame based on the enhancement residual and the intermediate image frame.

5. The method of claim 4, wherein the enhancement model is obtained based on:
determining, based on the reference mapping frame, a predicted value of an enhancement residual corresponding to the first reference image frame using the enhancement model; and
determining the enhancement model based on the predicted value and the first reference image frame.

6. The method of claim 5, wherein the first reference image frame is an intermediate reference image frame located at a position other than a head and a tail and selected from a reference image sequence.

7. The method of claim 6, wherein the second reference image frame is an intermediate image frame corresponding to the first reference image frame and selected from an encoded image sequence of the reference image sequence.

8. The method of claim 4, wherein determining the enhancement residual of the intermediate image frame using the enhancement model comprises:
extracting a feature from the intermediate image frame and the mapping frame using a feature extraction network in the enhancement model;
determining a fused feature of the intermediate image frame based on the feature using a fused attention network in the enhancement model; and
determining the enhancement residual based on the fused feature using a quality enhancement network in the enhancement model.

9. The method of claim 8, wherein determining the fused feature comprises:
determining a preliminary fused feature of the intermediate image frame based on the feature using a temporal attention network in the fused attention network; and
determining the fused feature of the intermediate image frame based on the preliminary fused feature using a spatial attention network in the fused attention network.

10. The method of claim 8, wherein determining the enhancement residual of the intermediate image frame comprises: determining the enhancement residual of the intermediate image frame based on the fused feature using a residual network in the quality enhancement network.

11. The method of claim 1, further comprising:
obtaining a set of enhanced image frames of the set of intermediate image frames, respectively; and
generating an enhanced image sequence corresponding to the image sequence using the head image frame, the set of enhanced image frames, and the tail image frame.

12. The method of claim 1, wherein the image sequence is obtained by decoding a compressed video using a variable resolution decoder, and the compressed video is obtained by performing an encoding operation on an original video using a variable resolution encoder.

13. The method of claim 1, wherein an image quality of the head image frame and the tail image frame is higher than an image quality of the set of intermediate image frames.

14. An electronic device, comprising:
at least one processor; and
at least one memory, the at least one memory being coupled to the at least one processor and storing instructions executable by the at least one processor, the instructions, when executed by the at least one processor, causing the electronic device to perform operations comprising:
obtaining an image sequence, a head and a tail of the image sequence comprising a head image frame and a tail image frame, respectively, and positions other than the head and the tail in the image sequence each comprising a set of intermediate image frames;
determining, for an intermediate image frame in the set of intermediate image frames, a mapping frame of the intermediate image frame according to an optical flow estimation based on at least one of the head image frame or the tail image frame; and
adjusting the intermediate image frame with the mapping frame to determine an enhanced image frame of the intermediate image frame.

15. The electronic device of claim 14, wherein determining the mapping frame of the intermediate image frame comprises: determining a forward mapping frame of the intermediate image frame according to the optical flow estimation based on the head image frame.

16. The electronic device of claim 14, wherein determining the mapping frame of the intermediate image frame comprises: determining a backward mapping frame of the intermediate image frame according to the optical flow estimation based on the tail image frame.

17. The electronic device of claim 14, wherein determining the enhanced image frame of the intermediate image frame comprises:
determining an enhancement residual of the intermediate image frame using an enhancement model, the enhancement model describing an association between a first reference image frame, a second reference image frame corresponding to the first reference image frame, and a reference mapping frame of the second reference image frame; and
determining the enhanced image frame based on the enhancement residual and the intermediate image frame.

18. The electronic device of claim 17, wherein the enhancement model is obtained based on:
determining, based on the reference mapping frame, a predicted value of an enhancement residual corresponding to the first reference image frame using the enhancement model; and
determining the enhancement model based on the predicted value and the first reference image frame.

19. The electronic device of claim 18, wherein the first reference image frame is an intermediate reference image frame located at a position other than a head and a tail and selected from a reference image sequence.

20. A non-transitory computer-readable storage medium, having a computer program stored thereon, the computer program, when executed by a processor, causing the processor to perform operations comprising:
obtaining an image sequence, a head and a tail of the image sequence comprising a head image frame and a tail image frame, respectively, and positions other than the head and the tail in the image sequence each comprising a set of intermediate image frames;
determining, for an intermediate image frame in the set of intermediate image frames, a mapping frame of the intermediate image frame according to an optical flow estimation based on at least one of the head image frame or the tail image frame; and
adjusting the intermediate image frame with the mapping frame to determine an enhanced image frame of the intermediate image frame.
